(19) United States
(12) Patent Application Publication
(10) Pub. No.: US 2013/0292877 A1
(43) Pub. Date: Nov. 7, 2013

(54) NANOIMPRINTING METHOD

(71) Applicant: FUJIFILM Corporation, Tokyo (JP)

(72) Inventors: Atsushi TATSUGAWA, Haibara-gun (JP); Masafumi YOSHIDA, Haibara-gun (JP)

(21) Appl. No.: 13/932,688

(22) Filed: Jul. 1, 2013

Related U.S. Application Data
(63) Continuation of application No. PCT/JP2012/051284, filed on Jan. 17, 2012.

(30) Foreign Application Priority Data
Jan. 19, 2011 (JP) 008519/2011

(51) Int. Cl. B29C 59/02

(52) U.S. Cl. CPC B29C 59/026
USPC 264/293

(57) ABSTRACT

A mold equipped with a substrate having a fine pattern of protrusions and recesses and a mold release layer formed along the pattern of protrusions and recesses on the surface thereof is employed to press resist coated on a substrate, to form a resist pattern, to which the pattern of protrusions and recesses is transferred. The thickness of the mold release layer and the pressing force with which the mold is pressed against the resist are controlled such that the line width of the resist pattern becomes a desired value. The width of the lines of the resist pattern is controlled by this configuration.

### TECHNICAL FIELD

The present invention is related to a cleansing method for cleansing a nanoimprinting mold having a predetermined pattern of protrusions and recesses on the surface thereof, after mold is employed to perform nanoimprinting.

### BACKGROUND ART

There are high expectations regarding utilization of pattern transfer techniques that employ a nanoimprinting method to transfer patterns onto resist coated on objects to be processed, in applications to produce magnetic recording media such as DTM (Discrete Track Media) and BPM (Bit Patterned Media) and semiconductor devices.

The nanoimprinting method is a development of the well known embossing technique employed to produce optical discs. In the nanoimprinting method, a metal original (commonly referred to as a mold, a stamper, or a template), on which a pattern of protrusions and recesses is formed, is pressed against resist coated on an object to be processed. Pressing of the original onto the resist causes the resist to mechanically deform or to flow, to precisely transfer the fine pattern. If a mold is produced once, nano level fine structures can be repeatedly molded in a simple manner. Therefore, the nanoimprinting method is an economical transfer technique that produces very little harmful waste and discharge. Therefore, there are high expectations with regard to application of the nanoimprinting method in various fields.

Conventionally, it is an important objective to improve the release properties between a mold and resist, from the viewpoint of pattern formation properties of a resist pattern (the ease with which a resist pattern can be formed according to design), accompanying refinements in patterns of protrusions and recesses.

Therefore, Japanese Unexamined Patent Publication Nos. 2002-283354, 2004-351693, 2007-326367, and 2008-178984, for example, disclose improving release properties by forming mold release layers including organic compounds on the surfaces of molds, to form resist patterns without defects.

### DISCLOSURE OF THE INVENTION

If a single mold is employed to perform nanoimprinting operations continuously, a problem may occur that the mold will become worn due to cleansing of the mold after nanoimprinting operations. In such cases, the heights and widths of lines of a pattern of protrusions and recesses of the mold will become smaller. The line width of resist patterns formed using the mold will change according to the degree of wear. Therefore, resist patterns cannot be formed according to their designs.

Such shifting of the dimensions of a mold from designed values results in deteriorated pattern formation properties of resist patterns. The influence of such deterioration will be more evident as the pattern of protrusions and recesses become finer. Accordingly, there are cases in which pattern formation properties cannot be sufficiently improved merely by forming mold release layers as in the methods disclosed in Patent Documents 1 through 4.

The present invention has been developed in view of the foregoing circumstances. It is an object of the present invention to provide a nanoimprinting method that enables pattern formation properties of resist patterns to be improved over conventional techniques.

A nanoimprinting method of the present invention that achieves the above object is that which employs a mold equipped with: a substrate having a fine pattern of protrusions and recesses thereon; and a mold release layer formed along the pattern of protrusions and recesses on the surface thereof, comprising:

pressing the mold against resist coated on a substrate to form a resist pattern to which the pattern of protrusions and recesses has been transferred, and is characterized by:

the thickness of the mold release layer and the intensity of the pressing force when pressing the mold against the resist being controlled such that the line width of the resist pattern becomes a desired value.

In the nanoimprinting method of the present invention, it is preferable for the thickness of the mold release layer to be controlled by adjusting the molecular length of a compound that constitutes the mold release layer.

In the nanoimprinting method of the present invention, it is preferable for the molecular length of the compound to be adjusted to be within a range from 5 Å to 30 Å; and for the pressing force to be adjusted to be within a range from 20 psi to 300 psi.

In the nanoimprinting method of the present invention, it is preferable for the compound to be a fluorine compound.

In the nanoimprinting method of the present invention, it is preferable for the compound to have a functional group which is capable of chemically bonding with the material that constitutes the substrate of the mold; and for the mold release layer to include a molecular film of the compound which is bound to the surface of the substrate by the functional group.

In the nanoimprinting method of the present invention, it is preferable for the compound to be a perfluoropolyether.

In the nanoimprinting method of the present invention, it is preferable for the mold release layer to have a monomolecular film structure formed by the compound.

According to the nanoimprinting method of the present invention, a mold equipped with: a substrate having a fine pattern of protrusions and recesses thereon; and a mold release layer formed along the pattern of protrusions and recesses on the surface thereof is employed. The nanoimprinting method comprises the step of pressing the mold against resist coated on a substrate to form a resist pattern to which the pattern of protrusions and recesses has been transferred, and is characterized by the thickness of the mold release layer and the intensity of the pressing force when pressing the mold against the resist being controlled such that the line width of the resist pattern becomes a desired value. This configuration enables the line width and the aspect ratio of the resist pattern, to which the pattern of protrusions and recesses has been transferred, to be controlled. This is considered to be because the degree of orientation of the compound that constitutes the mold release layer changes according to the pressing force, the thickness of the mold release layer changes, and as a result, the spaces among lines of the pattern of protrusions and recesses formed on the mold (excluding regions in which the mold release layer is provided) change. Thereby, resist patterns having line widths as designed can be formed even if the mold becomes worn. Accordingly, pattern formation properties of nanoimprinting can be improved compared to conventional techniques.

### BRIEF DESCRIPTION OF THE DRAWINGS

FIG. 1A is a sectional diagram that schematically illustrates a mold employed in a nanoimprinting method according to a first embodiment of the present invention.

FIG. 1B is a partial enlarged diagram that schematically illustrates the cross section of a portion of a pattern of protrusions and recesses of the mold illustrated in FIG. 1A.

FIG. 2A is a sectional diagram that schematically illustrates a state during a pressing operation of a nanoimprinting method in the case that pressing force is small.

FIG. 2B is a sectional diagram that schematically illustrates a state during a pressing operation of a nanoimprinting method in the case that pressing force is great.

### BEST MODE FOR CARRYING OUT THE INVENTION

Hereinafter, embodiments of the present invention will be described with reference to the attached drawings. However, the present invention is not limited to the embodiments to be described below. Note that the dimensional scale ratios, etc. of the constituent elements within the drawings are not necessarily as the actual scale ratios in order to facilitate visual understanding.

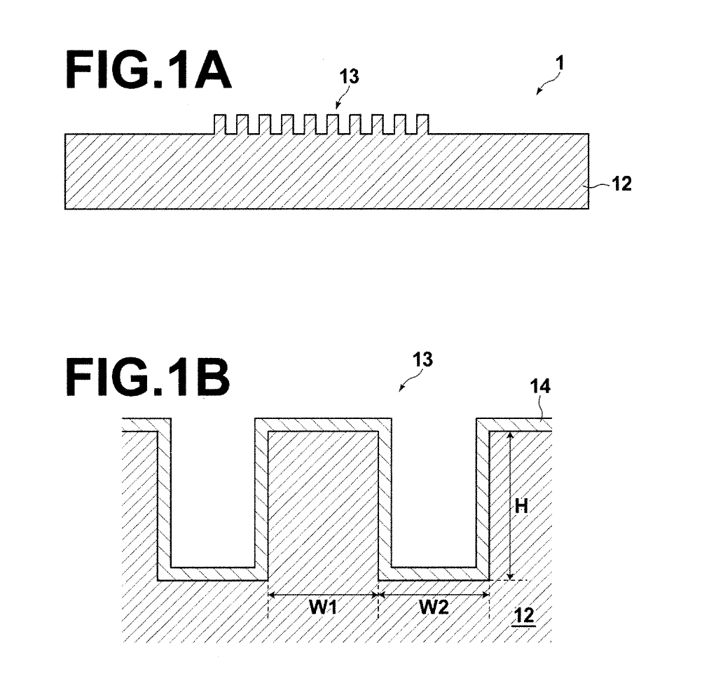

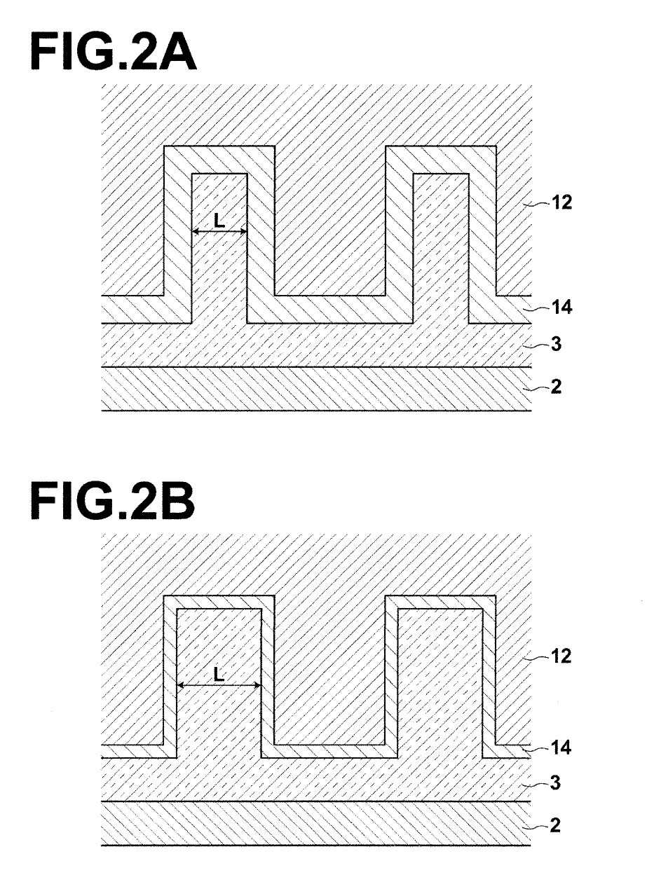

FIG. 1A is a sectional view that schematically illustrates a mold employed in a nanoimprinting method according to a first embodiment of the present invention. FIG. 1B is a partial enlarged view that schematically illustrates the cross section of a portion of a pattern of protrusions and recesses of the mold illustrated in FIG. 1A. FIG. 2A and FIG. 2B are sectional views that schematically illustrate states during pressing operations of a nanoimprinting method.

The nanoimprinting method of the first embodiment employs a mold 1 a mold 1 equipped with a substrate 12 having a pattern 13 of protrusions and recesses and a mold release layer 14 including a compound having a predetermined length, as illustrated in FIG. 1A through FIG. 2B. The nanoimprinting method of the first embodiment executes nanoimprinting operations using a predetermined amount of pressing force that takes the length of the compound into consideration, such that the line width of resist patterns becomes a desired value. More specifically, a substrate is coated with a photocuring resist 3, and the mold 1 is pressed against the resist at the predetermined amount of pressing force, such that the line width of resist patterns becomes a desired value. The resist 3 is caused to deform according to the pattern 13 of protrusions and recesses, then exposed by ultraviolet light through the substrate 2 or the mold 1, whichever is transparent, to cure the resist 3 and form a resist film. After the resist 3 is cured, the mold 1 is separated from the resist film, to form a resist film to which the pattern 13 of protrusions and recesses has been transferred.

As illustrated in FIGS. 1A and 1B, the mold 1 is constituted by the substrate 12 having the fine pattern 13 of protrusions and recesses on the surface thereof, and the mold release layer 14 that covers the pattern 13 of protrusions and recesses.

The material of the substrate 12 may be: a metal, such as silicon, nickel, aluminum, chrome, steel, tantalum, and tungsten; oxides, nitrides, and carbides thereof. Specific examples of the material of the substrate 12 include silicon oxide, aluminum oxide, quartz glass, Pyrex™, glass, and soda glass.

The shape of the pattern 13 of patterns and recesses is not particularly limited, and may be selected as appropriate according to the intended use of nanoimprinting. Atypical pattern is the line and space pattern such as that illustrated in FIGS. 1A and 1B. The length of the lines (protrusions), the width W1 of the lines, the distance W2 among the lines, and the height H of the lines from the bottoms of the recesses are set as appropriate in the line and space pattern. For example, the width W1 of the lines is within a range from 10 nm to 100 nm, more preferably within a range from 20 nm to 70 nm, the distance W2 among the lines is within a range from 10 nm to 500 nm, more preferably within a range from 20 nm to 100 nm, and the height H of the lines (the depth of the spaces) is within a range from 10 nm to 500 nm, more preferably within a range from 30 nm to 100 nm. Alternatively, the shape of the pattern 13 of protrusions and recesses may be that in which dots that represent cross sections of rectangles, circles, ovals, etc. are arranged.

The pressing force when the mold is pressed against the resist is set as appropriate according to the number of times that nanoimprinting operations are performed using the mold, the type of compound that constitutes the mold release layer, and the type of resist employed in the nanoimprinting operations. This is because there is a possibility that the dimensions of the pattern of protrusions and recesses will change due to the degree of wear progressing in the case that the number of executed nanoimprinting operations becomes great. In addition, different types of compounds that constitute the mold release layer facilitate changes in the orientations thereof. That is, the nanoimprinting method of the present invention is executed after the above information is obtained. It is preferable for the pressing force to be adjusted to be within a range from 20 psi to 300 psi. Note that the pressing force is a value measured by a pressure gauge or a force gauge. If the pressing force is less than 20 psi, the filling rate of resist within the recesses of the pattern of protrusions and recesses when the old is pressed against the resist will decrease, and it becomes difficult to foam a desired resist pattern according to the design of the mold. If the pressing force is greater than 300 psi, the orientation of the compound within the mold release layer becomes disrupted, resulting in the mold release properties and control properties with respect to the line width of resist patterns to deteriorate.

The mold release layer 14 is a layer that includes a compound having a predetermined length. It is preferable for the compound to be a fluorine compound. However, it is preferable for the fluorine compound to be that having low acidity, and not to be a compound that may damage the substrate, such as hydrogen fluoride, ammonium fluoride, tetramethylammonium fluoride, ammonium hydrogen fluoride, fluoroboric acid, and tetramethylammonium tetrafluoroborate. Further, it is preferable for the fluorine compound to have a functional group that chemically bonds to the material of the mesa type substrate 10 (that is, the mesa portion 12), from the viewpoint of improving the close contact properties between the mesa type substrate 10 and the mold release layer 14. It is also preferable for the mold release layer 14 to contain a molecular film of the fluorine compound bound to the surface of the mesa type substrate 10 by the functional group.

The thickness of the mold release layer 14 is set as appropriate, taking the degree of wear of the mold 1, the pressing force, etc., into consideration. It is possible to control the thickness of the mold release layer 14 by adjusting the molecular length of the compound that constitutes the mold release layer 14 (the maximum length of the molecular compound, which corresponds to the length within a single layer of the molecular film), and also by adjusting the number of layers within the molecular film. It is preferable for the molecular length of the compound to be within a range from 5 Å to 30 Å. If the molecular length of the compound is shorter than 5 Å, the surface of the mold will not be sufficiently coated by the compound, and mold release failures will become likely to occur. If the molecular length of the compound is longer than 30 Å, it becomes likely that resist will be hindered from filling the fine mold line widths. In addition, it is preferable for the mold release layer 14 to include a monomolecular film structure of the compound, taking the convenience in adjusting the thickness thereof into consideration. This structure is formed by coating the mold with a mold release agent (a solution that contains a compound which is a precursor to the compound that constitutes the mold release layer), then removing excess mold release agent which has not adsorbed onto the mold with a rinsing step. However, it is not necessary for the molecular length of the compound and the thickness of the mold release layer 14 having the monomolecular structure to strictly match. This is because there are cases in which measurement of the thickness of the mold release layer 14 results in the thickness of the monomolecular structure mold release layer 14 being less than the molecular length of the compound, because the thickness of the mold release layer 14 is averaged as a whole according to the degree of orientation of the compound that constitutes the mold release layer 14 and the coating rate thereof.

The method by which the mold release layer is formed generally includes the four steps of: a cleansing step; a coating step; an adsorption promoting step; and a rinsing step. The cleansing step is performed to cleanse and/or to activate the surface of the main body of the mold. The specific cleansing method is not particularly limited. Examples of such cleansing methods include: ultrasonic processing; UV irradiation; and plasma processing. If the surface of the mold is sufficiently cleansed and activated, this step may be omitted. The coating step is a step in which the surface of the mold main body is coated with the mold release agent. The specific coating method is not particularly limited, and various known coating methods may be employed. Examples of such known coating methods include: the dip coat method; the spin coat method; and the vapor exposure method. The adsorption promoting step is performed with the objective of promoting adsorption of the mold release agent onto the surface of the mold. The specific method to be employed is not particularly limited, and examples include: an annealing process; and UV irradiation. It is preferable for the annealing process to be performed at a temperature within a range from 50° C. to 150° C. In the case that UV irradiation is performed, it is preferable for a UV lamp that emits light having a wavelength of 185 nm or 254 nm to be utilized. The rinsing step is a step for rinsing the mold. The rinsing step removes excess mold release agent coated on the surface of the mold. The specific rinsing method is not particularly limited, and examples of rinsing methods include: ultrasonic cleansing; and the dip rinse method. The amount of time that ultrasonic cleansing is to be administered is not particularly limited, and may be within a range from 10 seconds to 10 minutes. The dip rinse method is a method in which an object is immersed in a solvent to perform rinsing, and the amount of time that the mold is immersed may be within a range from 10 seconds to 30 minutes. The solvent to be employed in the dip rinse method is not particularly limited, but it is preferable for the same solvent which is employed to prepare the mold release agent to be employed.

Considering the above, examples of the compound to be employed in the nanoimprinting method of the present invention include perfluoroalkyltrimethoxysilane and perfluoropolyether. An example of a perfluoropolyether having a functional group capable of chemically bonding with the material of the mesa type substrate 10 is that represented by the following Chemical Formula (1).

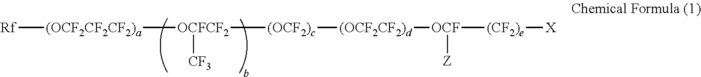

In Chemical Formula (1), Rf is not particularly limited as long as it is a perfluoroalkyl group. Examples of perfluoroalkyl groups are those having carbon numbers within a range from 1 to 16. The perfluoroalkyl group may be a straight chain or branched. Preferred examples of the perfluoroalkyl group are: CF₃—; C₂F₅—; and C₃F₇—. Z represents a fluorine or a trifluoromethyl group. Each of a through e represents an integer 0 or greater, and is a repetitive unit number of repetitive units within the parentheses of the perfluoropolyether chain. Here, the value of a+b+c+d+e is at least 1. It is preferable for each of a through e to be within a range from 0 to 200, and more preferably to be within a range from 0 to 50, taking the number average molecular weight of the perfluoropolyether to be described later into consideration. It is preferable for the value of a+b+c+d+e to be within a range from 1 to 100.

The order of the repetitive units within the parentheses, to which a through e are appended, is written in the above order in Chemical Formula (1) for the sake of convenience. However, the order of the repetitive units is not limited to that of Chemical Formula (1), in view of the structure of the perfluoropolyether.

X is a functional group which is capable of chemically bonding with the material of the mesa type substrate 10. The expression “capable of chemically bonding” refers to the functional group chemically reacting with the material of the mesa type substrate 10 when placed in contact with the mesa type substrate 10 at a temperature within a range from room temperature to approximately 200° C., and with added humidity if necessary. Whether the perfluoropolyether is chemically bound can be confirmed by sufficiently cleansing the surface of the mesa type substrate 10 with an agent that dissolves the perfluoropolyether after the above reaction, and then by measuring the contact angle of the surface. The functional group X may be selected according to the material of the mesa type substrate 10. From the viewpoint of reaction properties, preferred examples of the functional group X are: hydrolysable groups that include silicon atoms, titanium atoms, or aluminum atoms; phosphono groups; carboxyl groups; hydroxyl groups; and mercapto groups. Among these, hydrolysable groups that include silicon atoms are preferred. Particularly in the case that X is a hydrolysable group that includes silicon atoms, it is preferable for X to be a group represented by the following Chemical Formula (1-1).

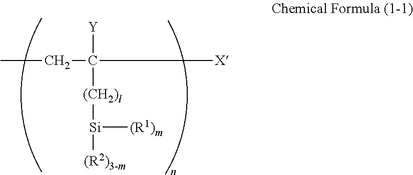

In Chemical Formula (1-1), Y represents a hydrogen atom or an alkyl group having a carbon number within a range from 1 to 4. The alkyl group having a carbon number within a range from 1 to 4 is not particularly limited, and examples include methyl, ethyl, propyl, and butyl. The alkyl group having a carbon number may be a straight chain or branched. In Chemical Formula (1-1), X′ represents a hydrogen atom, a bromine atom, or an iodine atom. In Chemical Formula (1-1), 1 represents the carbon number of an alkylene group which is present between a carbon within the perfluoropolyether chain and silicon that binds to the carbon. The value of 1 is 0, 1, or 2, and is preferably 0.

In Chemical Formula (1-1), m represents the number of bonds of a substituent group R¹ that bonds with silicon, and has a value of 1, 2, or 3. At portions at which the substituent group R⁴ is not bound, R² is bonded to the silicon.

In Chemical Formula (1-1), R¹ represents a hydroxyl group or a hydrolysable substituent group. The hydrolysable substituent group is not particularly limited, and preferred examples include: halogen; —OR^{3; —OCOR}³; —OC(R³)═C(R⁴)₂; —ON═C(R³)₂; —ON═CR⁵ (here, R³ represents an aliphatic hydrocarbon group or an aromatic hydrocarbon group, and R⁴ represents an aliphatic hydrocarbon group having a hydrogen or a carbon number from 1 to 4, and R⁵ represents a bivalent aliphatic hydrocarbon group having a carbon number from 3 to 6). More preferred examples include: chlorine; —OCH₃; and —OC₂H₅. Here, R² represents hydrogen or a monovalent hydrocarbon group. The monovalent hydrocarbon group is not particularly limited, and preferred examples include: methyl; ethyl; propyl; and butyl. The monovalent hydrocarbon may be a straight chain or branched.

In Chemical Formula (1-1), n represents an integer of 1 or greater. Although there is no upper limit to the value of n, it is preferable for n to be an integer within a range from 1 to 10, in order to achieve the objective of the present application. Although in Chemical Formula (1-1), n represents an integer, the perfluoropolyether of the present invention may be present as a component in a polymer mixture represented by Chemical Formula (1) having the integer n therein. In the case that perfluoropolyether is present as a component of a mixture, n may be represented as an average value within the mixture. Considering the objective of the present invention, it is preferable for the average value of n to be within a range from 1.3 to 3, and more preferably within a range from 1.5 to 2.5 in the case that the perfluoropolyether is present as a component of a mixture.

The number average molecular weight of the perfluoropolyether of Chemical Formula (1) is within a range from 5.10² to 1.10⁵. If the number average molecular weight of the perfluoropolyether is less than 5.10², polymer properties are not exhibited and therefore the perfluoropolyether has no utility value. If the number average molecular weight of the perfluoropolyether exceeds 1.10⁵, workability deteriorates. Therefore, the number average molecular weight of the perfluoropolyether of Chemical Formula (1) is limited to the above range. A more preferred range of number average molecular weights is from 1.10³ to 1.10⁴.

Taking the above description into consideration, a preferred example of the perfluoropolyether is that represented by Chemical Formula (1-2).

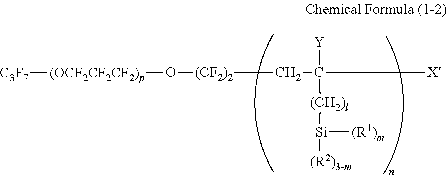

In Chemical Formula (1-2), p represents an integer of 1 or greater and is not particularly limited, although it is preferable for p to be an integer within a range from 1 to 20. Taking the number average molecular weight of a fluorine polymer that includes silicon of the present invention into consideration, a more preferred range for the value of p is 1 to 50. A commercially available produce may be employed as the perfluoropolyether. In the case that X is a hydrolysable group that includes silicon atoms, such a group may be obtained by employing a commercially available perfluoropolyether as a raw material, introducing iodine into the ends thereof, then causing a vinyl silane compound represented by Chemical Formula (1-3) (in Chemical Formula (1-3), Y, R¹, R², l, and m are the same as those described above) below, for example, to react therewith.

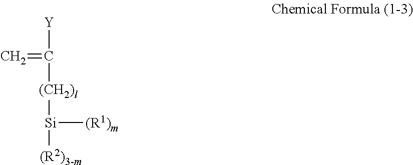

Further, in the case that the perfluoropolyether is that represented by Chemical Formula (1), it is preferable for the perfluoropolyether to be that represented by Chemical Formula (2) below.

C₃F₇(OCF₂CF₂CF₂)ₚOC₂F₄C₂H₄—Si(OCH₃)₃ Chemical Formula (2):

In Chemical Formula (2), p represents an integer 1 or greater that represents a degree of polymerization.

Alternatively, the perfluoropolyether may be that represented by Chemical Formula (3) below.

PₙRₘ₋ₙM-Z—Y—X—(OC₃F₆)ₐ—(OC₂F₄)_{b}—(OCF₂)_{c}—O—X—Y—Z-MPₙRₘ₋ₙ Chemical Formula (3):

In Chemical Formula (3), each of a through c represents an integer 0 or greater, and a+b+c is at least 1. The order of the repetitive units within the parentheses to which a through c are appended may be arbitrary within Chemical Formula (3).

In Chemical Formula (3), X represents a group represented by Chemical Formula (3-1): -(o)_{d}-(CF₂)ₑ—(CH₂₎_{f}— (here, each of d, e, and f represents a integer 0 or greater, the sum of e and f is at least 1, the order of the repetitive units within the parentheses to which d through f are appended may be arbitrary within Chemical Formula (3-1), and 0 is not continuous). Y represents a bivalent polar group or a single bond. Z represents a group represented by Chemical Formula (3-2): —(CH₂₎_{g}— (here, g represents an integer 0 or greater). -MPₙRₘ₋ₙ represents a functional group which is capable of chemically bonding with the material of the mesa type substrate 10. M represents a silicon atom, a titanium atom, or an aluminum atom. P represents a hydroxyl group or a hydrolysable polar group. R represents hydrogen or a hydrocarbon group. m represents an integer having a value one less than the valence of the atom represented by M. n represents an integer within a range from 1 to m. —OC₃F₆ represents —OCF₂CF₂CF₂— or —OCF(CF₃)CF₂—. —OC₂F₄— represents —OCF₂CF₂— or —OCF(CF₃)—.

Further, a, b, and c in Chemical Formula (3) are integers each within a range from 0 to 200. Preferred ranges for a, b, and c are from 1 to 100, considering the number average molecular weight of a polymer including fluorine.

In Chemical Formula (3-1) that represents X of Chemical Formula (3), each of d, e, and f is preferably an integer within a range from 0 to 50. Here, the values of d, e, and f are preferably 0, 1, or 2. More preferably, d=0 or 1, e=2, and f=0 or 1.

Examples of the bivalent polar group represented by Y in Chemical Formula (3) include: —COO—; —OCO—; —CONH—; —NHCO—; —OCH₂CH(OH)CH₂—; —CH₂CH(OH)CH₂O—; —COS—; —SCO—; and —O—. Among these, —COO—, —CONH—, —OCH₂CH(OH)CH₂—, and —CH₂CH(OH)CH₂O— are preferable.

In Chemical Formula (3-2) that represents Z of Chemical Formula (3), g is an integer within a range from 0 to 50, and preferably 0, 1, 2, or 3.

In Chemical Formula (3), M of the functional group -MPₙRₘ₋ₙ represents a metal element belonging to any one of groups 1 through 15 of the periodic table, and is preferably a silicon atom, a titanium atom, or an aluminum atom. Among these, a silicon atom is particularly preferred as M. —SiPₙR₃₋ₙ which is a hydrolysable group that includes a silicon atom is preferred as the functional group —MPₙRₘ₋ₙ.

The valence number of M in Chemical Formula (3) depends on the properties of the metal atom represented by M, but is generally within a range from 1 to 5, for example, within a range from 2 to 5, and particularly within a range from 3 to 5. For example, in the case that M represents a silicon atom (Si), m=3, and n=1, 2, or 3. However, it is often the case that polymers including fluorine are present as mixtures of polymers represented by Chemical Formula (3) having different values for n. In the case that polymers including fluorine are present as mixtures of polymers, n may be an average value within the mixture.

In Chemical Formula (3), the hydrocarbon group represented by R is preferably a monovalent hydrocarbon group that includes 1 to 5 carbon atoms. Specific examples of such monovalent hydrocarbon groups include alkyl groups such as: —CH₃; —C₂H₅; —C₃H₇; and —C₄H₉. The monovalent hydrocarbon group may be a straight chain or branched.

In Chemical Formula (3), the hydrolysable substituent group represented by P is not particularly limited. Preferable examples include: halogen; —OR²; —OCOR²; —OC(R²)═C(R³)₂; and —ON═CR⁴ (here, R² represents an aliphatic hydrocarbon group or an aromatic hydrocarbon group, R³ represents hydrogen or an aliphatic hydrocarbon group having a carbon number from 1 to 4, and R⁴ represents a bivalent aliphatic hydrocarbon group having a carbon number from 3 to 6). Chlorine, —OCH₃, and —OC₂H₅ are particularly preferred as P.

The number average molecular weight of the perfluoropolyether in Chemical Formula (3) is the same as that in the case of Chemical Formula (1).

In Chemical Formula (3), the perfluoropolyether in which Y is a bivalent polar group is preferably synthesized by causing a compound represented by Chemical Formula (3-3) and a compound represented by Chemical Formula (3-4) to react with each other.

Q-Z-M-PₙRₘ₋ₙ Chemical Formula (3-3):

In Chemical Formula (3-3), Z, M, P, R, m, and n are the same as those described above with reference to Chemical Formula (3), and Q represents a polar group.

T-X—(OC₃F₆)ₐ—(OC₂F₄)_{b}—(OCF₂)_{c}—X-T Chemical Formula (3-4):

In Chemical Formula (3-4), X, a, b, and c are the same as those described above with reference to Chemical Formula (3), and T represents a polar group.

Y of Chemical Formula (3) is formed, by Q of Chemical Formula (3-3) and T of Chemical Formula (3-4) reacting with each other. That is, polar group Q and polar group T are polar groups capable of forming a bivalent polar group corresponding to Y. Examples of polar group Q include: —COOH; —OH; —NH₂; —SH; -Hal (halogen); and a group represented by Chemical Formula (3-5) below.

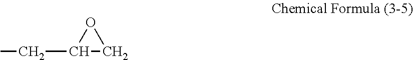

Examples of polar group T include: HO—; HOOC—; Hal-CO (acidic halide); H₂N; HS—; and a group represented by Chemical Formula (3-6) below.

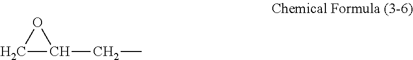

The reaction between the polar group Q and the polar group T may be realized as a known type of reaction (for example, a dehydration condensation reaction, an epoxy ring opening reaction, etc.).

Among the perfluoropolyethers represented by Chemical Formula (3), an example of a preferred compound is that represented by Chemical Formula (3-7) below.

Chemical Formula (3-7):

PₙRₘ₋ₙSi—Z—Y—X—(OC₃F₆)ₐ—(OC₂F₄)_{b}—(OCF₂)_{c}—O—X—Y—Z—SiPₙRₘ₋ₙ

In Chemical Formula (3-7), a, b, c, X, Y, Z, R, and P are the same as those described above with reference to Chemical Formula (3).

Further, in the case that the perfluoropolyether is that represented by Chemical Formula (3), it is preferably that represented by Chemical Formula (4) below.

(CH₃O)₃Si—CH₂CH₂CH₂—O—CH₂CF₂—(OCF₂CF₂)ⱼ—(OCF₂)ₖ—OCF₂CH₂—O—CH₂CH₂CH₂—Si(OCH₃₎₃ Chemical Formula (4):

In Chemical Formula (4), j and k are integers 1 or greater that represent degrees of polymerization.

The compound of Chemical Formula (4) may be produced, for example, by employing Fomblin ZDOL by Aujimont (presently Solvay Solexis). Fomblin ZDOL is a compound represented by Chemical Formula (4-1) below.

HO—CH₂CF₂—(OCF₂CF₂)ⱼ—(OCF₂)ₖ—OCF₂CH₂—OH Chemical Formula (4-1):

In Chemical Formula (4-1), j and k are integers 1 or greater that represent degrees of polymerization. The number average molecular weight of the compound is approximately 2000.

For example, the compound represented by Chemical Formula (4) can be obtained by the following steps. First, NaH (sodium hydride) is caused to react with Fomblin ZDOL represented by Chemical Formula (4-1) to cause the ends of the hydroxyl group to become sodium oxide. Then, aryl bromide is caused to react with the sodium oxide at the ends to arylate the hydroxyl groups at the ends. Thereafter, hydrosilylation is performed on the unsaturated compound using trichlorosilane (SiHCl₃). Finally, methanol is employed to substitute chlorine atoms on silicon with methoxy.

It is preferable for the mold release layer 14 to be formed by exposing the mesa type substrate 10 to perfluoropolyether. Thereby, a molecular film, in which the principal chains of the perfluoropolyether are arranged parallel to each other, can be obtained. Specifically, the formation process is performed as follows.

Perfluoropolyether is diluted with a fluorinated inert solvent to a concentration within a range from 0.01% by weight to 10% by weight, preferably a concentration within a range from 0.01% by weight to 1% by weight, and more preferably a concentration within a range from 0.01% by weight to 0.2% by weight. That is, it is preferable for the mold release layer to be formed by immersing the mesa type substrate 10 into such a diluted solution. Examples of the fluorinated inert solvent include: perfluorohexane; perfluoromethylcyclohexane; perfluoro-1,3-dimethylcyclohexane; and dichloropentafluoropropane (HCFC-225). The temperature during immersion is not particularly limited, and may be within a range from 0° C. to 100° C. The amount of time required for immersion varies according to the temperature during immersion. However, generally, 60 minutes or less is favorable, and approximately 1 minute is sufficient.

Alternatively, the mold release layer 14 may be formed by exposing the mesa type substrate 10 to perfluoropolyether vapor under decreased pressure conditions. The pressure in this case is not particularly limited, as long as it is less than 1 atmosphere and 0.1 atmosphere or greater. In order to expose the mesa type substrate 10 to the perfluoropolyether vapor, the mesa type substrate 10 may be left in an environment in which the diluted perfluoropolyether solution is heated and vaporized. Alternatively, the perfluoropolyether vapor may be blown onto the mesa type substrate 10. In this case, the temperature of the vapor may be within a range from 100° C. to 250° C.

The degree of coating of the mold release layer 14 including the sparsity and density of the layer (that is, the degree of bonding of the fluorine compound to the surface of the substrate 12) can be set as appropriate by adjusting the amount of time that the mesa type substrate 10 is exposed to the diluted fluorine compound solution or by adjusting the concentration of the diluted solution.

The nanoimprinting method of the present invention employs the mold 1 equipped with: the substrate 12 having the fine pattern 13 of protrusions and recesses thereon; and the mold release layer 14 formed along the pattern 13 of protrusions and recesses on the surface thereof. The nanoimprinting method comprises the step of pressing the mold 1 against the resist 3 coated on the substrate 2 to form a resist pattern to which the pattern 13 of protrusions and recesses has been transferred. In the nanoimprinting method of the present invention, the thickness of the mold release layer 14 and the intensity of the pressing force when pressing the mold 1 against the resist 3 are controlled such that the line width of the resist pattern becomes a desired value. FIGS. 2A and 2B are sectional views that illustrate states during a pressing operation of a nanoimprinting method in the case that the pressing force is small and in the case that the pressing force is great, respectively. As illustrated in FIGS. 2A and 2B, the degree of orientation of the compound that constitutes the mold release layer 14 changes due to the pressing force, the thickness of the mold release layer 14 changes, and as a result, the width L of the space filled by resist (the spaces among lines of the pattern of protrusions and recesses formed on the mold excluding regions in which the mold release layer is provided) changes. This is considered to be because the pressure applied onto the mold release layer 14 becomes greater in the case that the pressing force is great compared to the case that the pressing force is small, thereby changing the degree of orientation of the compound that constitutes the mold release layer 14 and changing the thickness of the mold release layer.

By the configuration described above enables the line width and the aspect ratio of the resist pattern, to which the pattern of protrusions and recesses has been transferred, to be controlled. Thereby, resist patterns having line widths as designed can be formed even if the mold becomes worn. Accordingly, pattern formation properties of nanoimprinting can be improved compared to conventional techniques.

### [Experiments]

Experiments conducted using a master mold of the present invention will be described below.

### <Production of the Mold>

A resist film was formed on a silicon substrate, by coating the silicon substrate with resist. A line and space pattern having a line width of 70 nm, intervals of 30 nm among lines, and a frequency of 100 nm was drawn, exposed, developed, and etched, to form a pattern of protrusions and recesses on the silicon substrate. A CD-SEM (Critical Dimension Scanning Electron Microscope) was employed to confirm that the intervals among lines were 30 nm as designed.

The substrate produced as described as above was prepared, and a mold release layer was formed using the compound represented by Chemical Formula (1-2) by the method to be described below. The compound that was actually utilized was perfluoropolyether represented by C₃F₇(OCF₂CF₂CF₂)ₚOC₂F₄C₂H₄—Si(OCH₃)₃ (number average molecular weight: 4000) represented by Chemical Formula (1-2), in which X′ and Y are —H, R¹ and R² are —OCH₃, 1 is 0, and m and n are 1. First, the surface of the silicon substrate on which the pattern of protrusions and recesses was formed was ultrasonically cleansed with an organic solvent. Next, the patterned surface was cleaned by undergoing a UV ozone treatment. Thereafter, the mesa type substrate was immersed for 1 minute in a diluted solution containing the perfluoropolyether at a concentration of 0.1% by weight, to chemically modify the surface of the silicon substrate with the perfluoropolyether. A fluorine inert solvent (perfluorohexane) was employed as the diluting solvent. After the immersion, an annealing process was administered on the silicon substrate at 100° C. Next, the silicon substrate was rinsed with a fluorine inert solvent (perfluorohexane) for 5 minutes. The value of p within Chemical Formula (1-2) was adjusted to control the molecular length of the compound (the thickness of the mold release layer).

### <Nanoimprinting Employing the Mold>

Resist was coated onto a quartz substrate. The mold obtained as described above was pressed against the resist film, and the resist was cured by irradiating UV light from the side of the quartz substrate, to form a resist film onto which the pattern of protrusions and recesses was transferred, then the mold was separated from the resist film. Experiments were conducted by setting the molecular length of the compound that constitutes the mold release layer and the pressing force during pressing of the resist as shown in Table 1.

### <Evaluations>

Defects in the resist patterns and ratios of the intervals among lines in the silicon substrate and the line widths of the resist patterns were evaluated under each of the nanoimprinting experimental conditions. Table 1 shows the experimental results for each of the nanoimprinting experimental conditions. Note that with respect to the defects in the resist patterns, cases in which defects were not generated in the resist pattern were evaluated as “Good”, and cases in which defects were generated were evaluated as “Poor”. As a result, it was confirmed that the line widths and aspect ratios of resist patterns can be controlled to desired values by adjusting the molecular length of the compound (the thickness of the mold release layer) and the pressing force when pressing the mold against the resist. In addition, it was seen that the pattern formation properties of the resist films were favorable in cases that the molecular length of the compound was adjusted to be within a range from 5 Å to 30 Å and the pressing force was adjusted to be within a range from 20 psi to 30 psi.

TABLE 1

| | Molecular | | | |
|---|---|---|---|---|
| | Length | Pressing | Defects in | Line Width |
| | (Å) | Force (psi) | Resist Pattern | Ratios |
| Experiment 1 | 2 | 300 | Poor | Poor |
| Experiment 2 | 5 | 15 | Poor | Poor |
| Experiment 3 | 5 | 20 | Good | 0.95 |
| Experiment 4 | 5 | 300 | Good | 0.99 |
| Experiment 5 | 15 | 20 | Good | 0.90 |
| Experiment 6 | 15 | 150 | Good | 0.95 |
| Experiment 7 | 15 | 300 | Good | 1.00 |
| Experiment 8 | 15 | 400 | Poor | Poor |
| Experiment 9 | 30 | 20 | Good | 0.82 |
| Experiment 10 | 30 | 100 | Good | 0.85 |
| Experiment 11 | 30 | 300 | Good | 0.98 |
| Experiment 12 | 35 | 350 | Poor | Poor |

What is claimed is :

1. A nanoimprinting method that employs a mold equipped with: a substrate having a fine pattern of protrusions and recesses thereon; and a mold release layer formed along the pattern of protrusions and recesses on the surface thereof, comprising:
pressing the mold against resist coated on a substrate to form a resist pattern to which the pattern of protrusions and recesses has been transferred, wherein:
the thickness of the mold release layer is caused to be thicker and/or the intensity of the pressing force when pressing the mold against the resist is caused to be smaller, according to the number of nanoimprinting operations executed using the mold, such that the line width of the resist pattern becomes a desired value.

2. A nanoimprinting method as defined in claim 1, wherein:
the thickness of the mold release layer is controlled by adjusting the molecular length of a compound that constitutes the mold release layer.

3. A nanoimprinting method as defined in claim 2, wherein:
the molecular length of the compound is adjusted to be within a range from 5 Å to 30 Å; and
the pressing force is adjusted to be within a range from 20 psi to 300 psi.

4. A nanoimprinting method as defined in claim 2, wherein:
the compound is a fluorine compound.

5. A nanoimprinting method as defined in claim 3, wherein:
the compound is a fluorine compound.

6. A nanoimprinting method as defined in claim 2, wherein:
the compound has a functional group which is capable of chemically bonding with the material that constitutes the substrate of the mold; and
the mold release layer includes a molecular film of the compound which is bound to the surface of the substrate by the functional group.

7. A nanoimprinting method as defined in claim 3, wherein:
the compound has a functional group which is capable of chemically bonding with the material that constitutes the substrate of the mold; and
the mold release layer includes a molecular film of the compound which is bound to the surface of the substrate by the functional group.

8. A nanoimprinting method as defined in claim 4, wherein:
the compound is a perfluoropolyether.

9. A nanoimprinting method as defined in claim 5, wherein:
the compound is a perfluoropolyether.

10. A nanoimprinting method as defined in claim 6, wherein:
the compound is a perfluoropolyether.

11. A nanoimprinting method as defined in claim 7, wherein:
the compound is a perfluoropolyether.

12. A nanoimprinting method as defined in claim 2, wherein:
the mold release layer has a monomolecular film structure formed by the compound.

13. A nanoimprinting method as defined in claim 3, wherein:
the mold release layer has a monomolecular film structure formed by the compound.

14. A nanoimprinting method as defined in claim 4, wherein:
the mold release layer has a monomolecular film structure formed by the compound.

15. A nanoimprinting method as defined in claim 5, wherein:
the mold release layer has a monomolecular film structure formed by the compound.

16. A nanoimprinting method as defined in claim 6, wherein:
the mold release layer has a monomolecular film structure formed by the compound.

17. A nanoimprinting method as defined in claim 7, wherein:
the mold release layer has a monomolecular film structure formed by the compound.

18. A nanoimprinting method as defined in claim 8, wherein:
the mold release layer has a monomolecular film structure formed by the compound.

19. A nanoimprinting method as defined in claim 9, wherein:
the mold release layer has a monomolecular film structure formed by the compound.

20. A nanoimprinting method as defined in claim 10, wherein:
the mold release layer has a monomolecular film structure formed by the compound.
